(19) United States
(12) Patent Application Publication
(10) Pub. No.: US 2021/0049383 A1
(43) Pub. Date: Feb. 18, 2021

(54) System And Method For Determining Parking Space Vacancy Using Solar Irradiance

(71) Applicant: Alex LaVelle, Long Beach, CA (US)

(72) Inventor: Alex LaVelle, Long Beach, CA (US)

(73) Assignee: Urbn, Inc., Garden Grove, CA (US)

(21) Appl. No.: 16/540,049

(22) Filed: Aug. 13, 2019

(51) Int. Cl. G06K 9/00; G01S 13/04; G01S 13/50; G01S 13/82; G01S 13/86; G08G 1/14

(52) U.S. Cl. CPC G06K 9/00812; G01S 13/04; G01S 13/50; G01S 13/825; G07B 15/02; G08G 1/142; G08G 1/144; G08G 1/146; G08G 1/147; G01S 13/867

(57) ABSTRACT

A system and an associated method for determining parking space vacancy using solar irradiance is disclosed. Whether a parking space is occupied by a vehicle or is currently vacant can be determined by taking frequent irradiance readings at one or more parking space sensors and comparing the irradiance readings to baseline irradiance readings and covered control irradiance readings taken at a separate central hub. When the solar irradiance readings at the parking space sufficiently approach the covered control irradiance reading—and thus sufficiently differ from the baseline solar irradiance reading at the hub—a determination can be made that the parking space is occupied by a vehicle and is therefore not vacant. In a preferred embodiment, the system is capable of largely powering itself by connecting the solar cell to a storage battery in each parking space sensor and/or coupling the uncovered hub solar cell to a storage battery in the hub.

### BRIEF DESCRIPTION OF THE INVENTION

The present invention is generally related to parking space vacancy determination, and more particularly related to a system and associated method for determining parking space vacancy using solar irradiance. In the herein disclosed system, frequent irradiance readings are carried out by one or more parking space sensors and compared to baseline irradiance readings and covered control irradiance readings carried out at a central hub.

All readings received at the hub can be communicated to a server at which a vacancy determination is made based upon an analysis of the parking space sensor data compared to the hub data. When the solar irradiance readings at the parking space sufficiently approach the covered control irradiance reading—and thus sufficiently differ from the baseline solar irradiance reading at the hub—a determination can be made that the parking space is occupied by a vehicle and is therefore not vacant.

Each of the parking space sensors includes a protective case to protect a solar cell and a temperature probe positioned within the parking space sensor; a solar irradiance present value reading may be calculated by utilizing both a solar cell reading and a temperature probe reading. Each of the parking space sensors is communicatively coupled to a central hub. The central hub includes a communication device plus a first solar cell for reading a local solar irradiance baseline value and a second covered solar cell for measuring a covered (or fully shaded) solar irradiance control value.

An exemplary embodiment of the herein disclosed system for determining parking space vacancy comprises a plurality of parking space sensors positioned on a street level of a parking space and communicatively coupled to a hub, wherein each parking space sensor is mounted to the street level of the parking space and includes a solar cell for measuring a solar irradiance present value and a temperature probe for measuring a present temperature; the hub includes a first hub solar cell for measuring a local solar irradiance baseline value, a second covered hub solar cell for measuring a covered solar irradiance control value, and a communication device communicatively coupled to a server and to the plurality of parking space sensors for receiving the solar irradiance present value and the present temperature from the plurality of parking space sensors; the server receives the solar irradiance present value, the present temperature, the local solar irradiance baseline value, and the covered solar irradiance control value, and determining whether the parking space is vacant.

In a preferred embodiment, the system is capable of largely powering itself by connecting the solar cell to a storage battery in each parking space sensor, thereby allowing the storage batter to store and utilize power generated by the solar cell. In certain embodiments, the hub may also be powered through solar power received by the uncovered hub solar cell.

An exemplary embodiment of the herein disclosed method for determining parking space vacancy comprises the steps of receiving one or more solar irradiance present values from one or more parking space sensors positioned on a street level of a parking space; receiving one or more present temperatures from the one or more parking space sensors; receiving a local solar irradiance baseline value from a hub; receiving a covered solar irradiance control value from the hub; and determining whether the parking space is vacant based upon the one or more solar irradiance present values, the one or more present temperatures, the local solar irradiance baseline value, and the covered solar irradiance control value.

### CROSS-REFERENCES TO RELATED APPLICATIONS

Not applicable.

### BACKGROUND OF THE INVENTION

The field of determining parking space availability for vehicles is in constant development. Currently available solutions involve video cameras to visually inspect parking spaces for vacancy and moving or static sensors that detect electromagnetic fields to determine vehicle occupancy. But it is heretofore unknown to utilize solar irradiance measurements to track parking space availability.

A parking space sensor that utilizes solar irradiance to determine vacancy is advantageous. There is no wear and tear caused by components moving along a track and there is no need for complex video analysis algorithms to determine vacancy from video. Instead, simple and relatively inexpensive solar cell components can be utilized to create a network of solar irradiance measurement sensors in communication with a separate central hub taking local control solar irradiance measurements. Data from the parking spaces and the central hub can be compared and a simple determination of whether a vehicle is parked above a parking space sensor can be made quickly and accurately using a solar irradiance system that is low maintenance and easy to install.

### BRIEF DESCRIPTION OF THE SEVERAL VIEWS OF THE DRAWING

FIG. 1 illustrates a general overview of the herein disclosed system for determining parking space vacancy using solar irradiance, in accordance with a preferred embodiment of the present invention;

FIG. 2 illustrates an overhead view of one or more parking space sensors and a hub, components of the herein disclosed system for determining parking space vacancy using solar irradiance, in accordance with a preferred embodiment of the present invention;

FIG. 3A illustrates a side view of an exemplary parking space sensor, a component of the herein disclosed system for determining parking space vacancy using solar irradiance, in accordance with a preferred embodiment of the present invention;

FIG. 3B illustrates an exemplary central hub, a component of the herein disclosed system for determining parking space vacancy using solar irradiance, in accordance with a preferred embodiment of the present invention; and

FIG. 4 includes a flow diagram illustrating an exemplary method for determining parking space vacancy using solar irradiance, in accordance with a preferred embodiment of the present invention.

### DETAILED DESCRIPTION OF THE INVENTION

A system and an associated method for determining parking space vacancy using solar irradiance is herein disclosed. Whether a parking space is occupied by a vehicle or is currently vacant can be determined by taking frequent irradiance readings at one or more parking space sensors and comparing the irradiance readings to baseline irradiance readings and covered control irradiance readings taken at a separate central hub. When the solar irradiance readings at the parking space sufficiently approach the covered control irradiance reading—and thus sufficiently differ from the baseline solar irradiance reading at the hub—a determination can be made that the parking space is occupied by a vehicle and is therefore not vacant.

An exemplary embodiment of the herein disclosed system for determining parking space vacancy comprises a plurality of parking space sensors positioned on a street level of a parking space and communicatively coupled to a hub, wherein each parking space sensor is mounted to the street level of the parking space and includes a solar cell for measuring a solar irradiance present value and a temperature probe for measuring a present temperature; the hub includes a first hub solar cell for measuring a local solar irradiance baseline value, a second covered hub solar cell for measuring a covered solar irradiance control value, and a communication device communicatively coupled to a server and to the plurality of parking space sensors for receiving the solar irradiance present value and the present temperature from the plurality of parking space sensors; the server receives the solar irradiance present value, the present temperature, the local solar irradiance baseline value, and the covered solar irradiance control value, and determining whether the parking space is vacant.

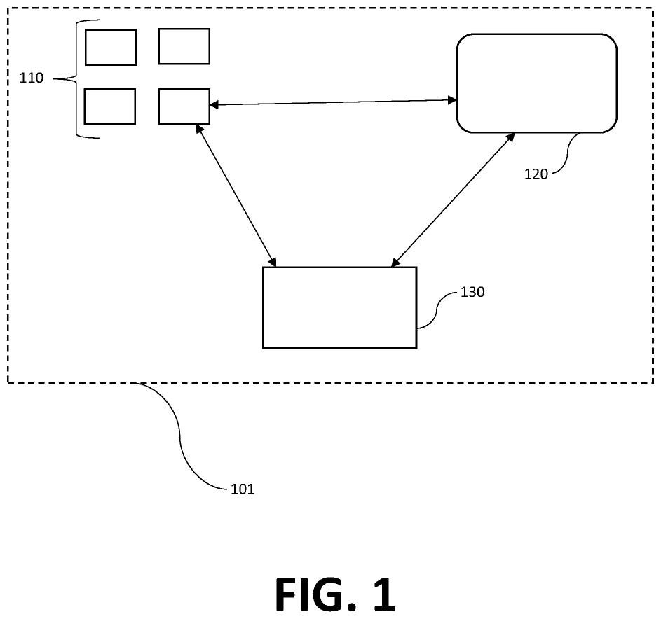

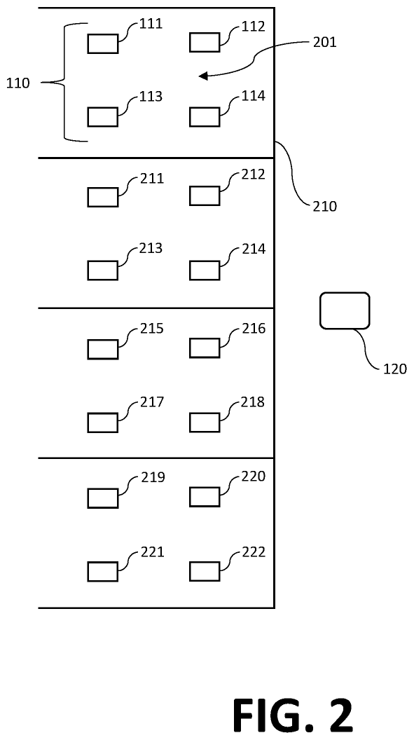

Referring to FIG. 1, a general overview of the herein disclosed system for determining parking space vacancy using solar irradiance is shown. System 101 for determining parking space vacancy includes one or more parking space sensors 110 communicatively coupled to separate central hub 120 (also referred to as hub 120) which is communicatively coupled to server 130. System 101 may be implemented with as little as a single parking space to determine whether the space is occupied by a vehicle or vacant. Alternatively, system 101 may be implemented with a plurality of parking spaces as is demonstrated in FIG. 2.

One or more parking space sensors 110 are distributed throughout the street level of one or more parking spaces. Each of the one or more parking space sensors 110 takes or carried out readings or measurements of solar irradiance and transfers the solar irradiance data to separate central hub 120. Hub 120 is positioned outside the parking spaces and may be connected wirelessly, or by a hardline connection, to each of the one or more parking space sensors 110. Such a wireless data connection may be a Bluetooth™ connection, a WiFi connection, or any other wireless data connection capable to transferring solar irradiance and/or temperature data from one or more parking space sensors 110 to central hub 120.

Hub 120 carries out its own solar irradiance measurements (a local solar irradiance baseline value and a covered solar irradiance control value) and transmits these measurements plus the measurements received from one or more parking space sensors 110 to server 130. Server 130 may be any server capable of receiving solar irradiance data, processing the solar irradiance data to make the determination as to whether the parking space is vacant, and transmitting or disseminating the vacancy determination to one or more users. A user is a person or entity interested in knowing whether the parking space, or the parking spaces, are vacant and thus available for use or occupied by a vehicle and therefore unavailable for use. For example, server 130 may disseminate the determination through a mobile application that is downloadable to the user's mobile device and displays vacancy information to the user in a graphical format. In another example, server 130 may disseminate the vacancy determination by displaying the vacancy determination on a display screen that is visible to parking lot attendant or a security guard.

Referring to FIG. 2, an overhead view of a plurality of parking space sensors 110 and a separate central hub 120 is shown. Parking space 201 is delineated by parking grid 210 and includes one or more parking space sensors 110. In the exemplary embodiment depicted in FIG. 2, four parking space sensors 110 may be distributed throughout a street level of each parking space. In the example, parking space 201 is monitored by first parking space sensor 111, second parking space sensor 112, third parking space sensor 113, and fourth parking space sensor 114. Each of the four parking space sensors are communicatively coupled to separate central hub 120 positioned separate from the parking spaces. Continuing with the example depicted in FIG. 2, subsequent parking spaces are also each monitored by four parking space sensors distributed throughout a street level of each parking space. Parking space sensors 211, 212, 213, and 214 may monitor a second parking space. Parking space sensors 215, 216, 217, and 218 may monitor a third parking space. And parking space sensors 219, 220, 221, and 222 may monitor a fourth parking space. As shown in FIG. 2, a preferred embodiment involves utilizing four parking space sensors 110 for each parking space, the four parking space sensors 110 arranged in a rectangular pattern inset from the edges of the parking space. Other arrangements for parking space sensors 110 are possible; for example, each parking space may utilize two parking space sensors spaced along a center line of the parking space or, alternatively, just a single parking space sensor 110 centrally positioned within the parking space.

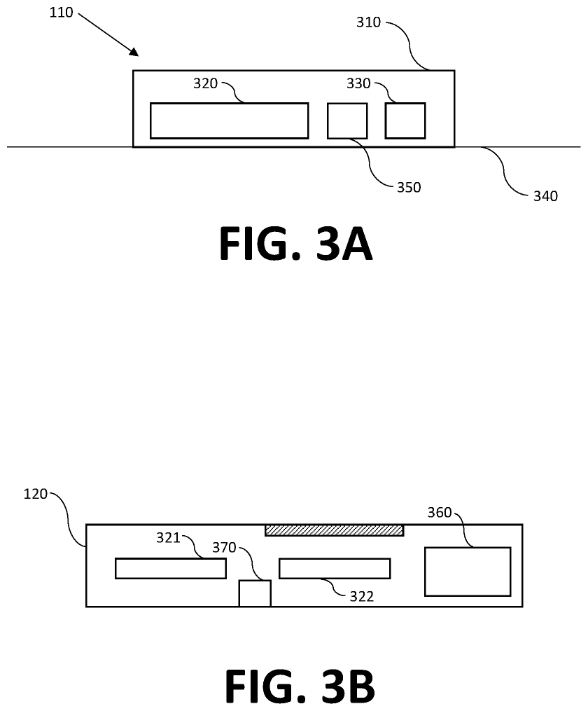

Referring to FIG. 3A and FIG. 3B, detailed views of the parking space sensor 110 component and the hub 120 component are shown. Parking space sensor 110 includes solar cell 320, temperature probe 330, and power supply 350 housed within case 310. Case 310 is secured to street level 340 of the parking space. Case 310 may be any rigid case that allows solar cell 320 to receive adequate light from directly above parking space sensor 110; in a preferred embodiment, case 310 is capable of withstanding the force of a vehicle (such as a car or truck) positioned above case 310 or driving over case 310. Power supply 350 may be any power supply capable of powering the components of parking space sensor 110; in a preferred embodiment, power supply 350 is connected to solar cell 320 and is a storage battery capable of storing solar energy collected by solar cell 320. Solar cell 320 may be any type of solar cell capable of measuring the light (or the solar irradiance or the isolation) directly above parking space sensor 110. Temperature probe 330 may be any type of temperature probe capable of measuring the temperature at the location of the parking space sensor 110.

Central hub 120 includes power supply 370, communication device 360 for communicating wirelessly with server 130, first hub solar cell 321 for measuring a local solar irradiance baseline value, and second covered hub solar cell 322 for measuring a covered solar irradiance control value. Power supply 370 may be any power supply capable of powering the components of hub 120; in a preferred embodiment, power supply 370 is connected to first hub solar cell 321 and is a storage battery capable of storing solar energy collected by first hub solar cell 321. Communication device 360 may be any type of communication device capable of wirelessly communicating with server 130; for example, communication device 360 may be capable of Bluetooth™ data transmission, WiFi data transmission, or radio data transmission. In certain embodiments, communication device 360 may also be in wireless communication with one or more parking space sensors 110. First hub solar cell 321 is a solar cell that is exposed to the ambient light directly above hub 120. Second covered hub solar cell 322 is a solar cell that is fully covered to measure a covered solar irradiance control value; for example, second covered hub solar cell 322 may be covered by a screen or other opaque structure formed by the case of hub 120.

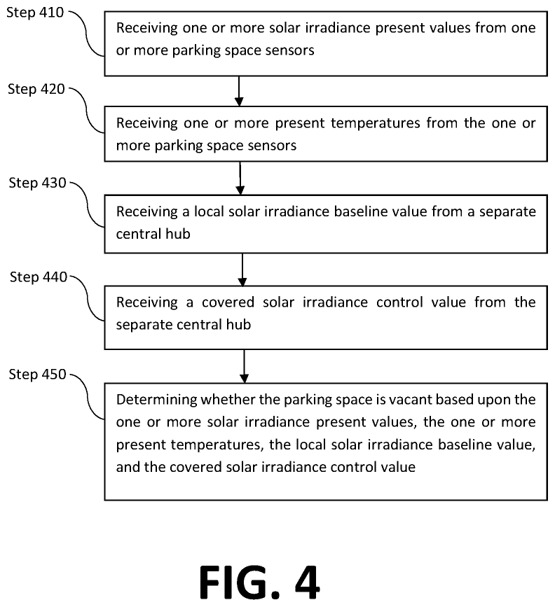

Referring to FIG. 4, a flow diagram is included to demonstrate an exemplary method for determining parking space vacancy using solar irradiance. A method for determining parking space vacancy includes Step 410 receiving one or more solar irradiance present values from one or more parking space sensors 110; Step 420 receiving one or more present temperatures from the one or more parking space sensors 110; Step 430 receiving a local solar irradiance baseline value from separate central hub 120; Step 440 receiving a covered solar irradiance control value from separate central hub 120; and Step 450 determining whether the parking space is vacant based upon the one or more solar irradiance present values, the one or more present temperatures, the local solar irradiance baseline value, and the covered solar irradiance control value. Certain embodiments may further include the step of disseminating the determination of whether the parking space is vacant to one or more users.

As is apparent from the discussion regarding FIG. 2, in a preferred embodiment Step 410 receiving one or more solar irradiance present values from one or more parking space sensors 110 may include receiving four independent solar irradiance present values (a first solar irradiance present value from a first parking space sensor, a second solar irradiance present value from a second parking space sensor, a third solar irradiance present value from a third parking space sensor, and a fourth solar irradiance present value from a fourth parking space sensor) corresponding to four parking space sensors 110 distributed throughout the street level of parking space 201 formed by parking grid 210. Certain embodiments of the herein disclosed methods may average all four independent solar irradiance present values or otherwise utilize all four independent solar irradiance present values in the Step 450 determination of whether the parking space is vacant.

An issue that may arise with the herein disclosed system and method is that a moving shadow or shade created by nearby objects or buildings can create a situation that may trigger a false occupied determination for the parking space. For example, as the day progresses a shadow cast by a nearby six-story building may progress across a parking lot and eventually plunge a vacant parking space completely into shadows, thus risking a false occupied determination for the parking space. To avoid or minimize this issue, the steps recited herein may be carried out at a high frequency (every 0.5 second, for example) and an occupied determination can be deferred until a sharp and/or immediate solar irradiance downturn is seen on the majority of parking space sensors 110. In other words, a slow decline in solar irradiance readings is to be marked as “vacant” as this situation is likely to be a shadow progressing across the parking space sensor 110, as opposed to a sudden solar irradiance shock that is more likely to be caused by a vehicle parking over the parking space sensor 110.

Throughout this specification reference has been made to each parking space sensor 110 having temperature probe 330 for measuring a temperature (referred to as a present temperature, see Step 420 in FIG. 4) in conjunction with each solar cell measurement or reading. Despite reference to temperature probe 330 and receiving a present temperature in Step 420, lesser preferred embodiments of the herein disclosed system and associated method may omit temperature probe 330 and/or Step 420 and all such embodiments are intended to be included herein as part of the present invention. In such embodiments, the determination of whether the parking space is vacant is based upon the one or more solar irradiance present values, the local solar irradiance baseline value, and the covered solar irradiance control value.

Furthermore, throughout this specification reference has been made to the step of using the collected solar irradiance data to determine whether the parking space is vacant (Step 450 of the method shown in FIG. 4) as being carried out at server 130. But certain lesser preferred embodiments can include a processor component at hub 120 for making the determination of Step 450, instead of making the determination of Step 450 at server 130, and all such embodiments are intended to be included herein as part of the present invention. In such an embodiment, hub 120 may make the determination of Step 450 and then transmit the determination to server 130 for further dissemination to one or more users.

While the present invention has been illustrated and described herein in terms of a preferred embodiment and several alternatives, it is to be understood that the devices, systems, and methods described herein can have a multitude of additional uses and applications. Accordingly, the invention should not be limited to just the particular description and various drawing figures contained in this specification that merely illustrate a preferred embodiment and application of the principles of the invention.

What is claimed is:

1. A system for determining parking space vacancy, comprising:
a plurality of parking space sensors positioned on a street level of a parking space and communicatively coupled to a hub, wherein each parking space sensor is mounted to the street level of the parking space and includes a solar cell for measuring a solar irradiance present value and a temperature probe for measuring a present temperature;
the hub including a first hub solar cell for measuring a local solar irradiance baseline value, a second covered hub solar cell for measuring a covered solar irradiance control value, and a communication device communicatively coupled to a server and to the plurality of parking space sensors for receiving the solar irradiance present value and the present temperature from the plurality of parking space sensors; and
the server for receiving the solar irradiance present value, the present temperature, the local solar irradiance baseline value, and the covered solar irradiance control value, and determining whether the parking space is vacant.

2. The system for determining parking space vacancy as recited in claim 1, wherein the plurality of parking space sensors include four parking space sensors distributed throughout the street level of the parking space.

3. The system for determining parking space vacancy as recited in claim 1, wherein the communication device can communicate wirelessly with the server.

4. The system for determining parking space vacancy as recited in claim 1, wherein the communication device can communicate wirelessly with the one or more parking space sensors.

5. The system for determining parking space vacancy as recited in claim 1, wherein determining whether the parking space is vacant involves averaging a plurality of readings of the solar irradiance present value received from the plurality of parking space sensors.

6. The system for determining parking space vacancy as recited in claim 1, wherein the plurality of parking space sensors includes a first parking space sensor for measuring a first solar irradiance present value, a second parking space sensor for measuring a second solar irradiance present value, a third parking space sensor for measuring a third solar irradiance present value, and a fourth parking space sensor for measuring a fourth solar irradiance present value.

7. The system for determining parking space vacancy as recited in claim 6, wherein determining whether the parking space is vacant involves utilizing the first solar irradiance present value, the second solar irradiance present value, the third solar irradiance present value, and the fourth solar irradiance present value.

8. The system for determining parking space vacancy as recited in claim 6, wherein determining whether the parking space is vacant involves averaging the first solar irradiance present value, the second solar irradiance present value, the third solar irradiance present value, and the fourth solar irradiance present value.

9. The system for determining parking space vacancy as recited in claim 1, wherein determining whether the parking space is vacant involves high frequency measurements from the plurality of parking space sensors to minimize shade triggering a false occupied determination.

10. The system for determining parking space vacancy as recited in claim 1, wherein the plurality of parking space sensors each further include a battery capable of storing a charge received from solar power captured by the solar cell.

11. The system for determining parking space vacancy as recited in claim 1, wherein the hub further includes a hub battery capable of storing a charge received from solar power captured by the first hub solar cell.

12. A method for determining parking space vacancy, comprising the steps of:
receiving one or more solar irradiance present values from one or more parking space sensors positioned on a street level of a parking space;
receiving one or more present temperatures from the one or more parking space sensors;
receiving a local solar irradiance baseline value from a hub;
receiving a covered solar irradiance control value from the hub; and
determining whether the parking space is vacant based upon the one or more solar irradiance present values, the one or more present temperatures, the local solar irradiance baseline value, and the covered solar irradiance control value.

13. The method for determining parking space vacancy as recited in claim 12, further comprising the step of disseminating the determination of whether the parking space is vacant to one or more users.

14. The method for determining parking space vacancy as recited in claim 12, wherein the one or more parking space sensors include a first parking space sensor having a first solar cell for measuring a first solar irradiance present value, a second parking space sensor having a second solar cell for measuring a second solar irradiance present value, a third parking space sensor having a third solar cell for measuring a third solar irradiance present value, and a fourth parking space sensor having a fourth solar cell for measuring a fourth solar irradiance present value, and wherein the step of determining whether the parking space is vacant involves utilizing the first solar irradiance present value, the second solar irradiance present value, the third solar irradiance present value, and the fourth solar irradiance present value.

15. The method for determining parking space vacancy as recited in claim 12, further comprising the step of repeating the recited steps at a high frequency to minimize shade triggering a false occupied determination.
